(19) United States
(12) Patent Application Publication
(10) Pub. No.: US 2023/0408243 A1
(43) Pub. Date: Dec. 21, 2023

(54) WEAR INTEGRITY MONITORING SYSTEM

(71) Applicant: Sean Aaron Mackiewicz, Williston, ND (US)

(72) Inventor: Sean Aaron Mackiewicz, Williston, ND (US)

(21) Appl. No.: 18/208,502

(22) Filed: Jun. 12, 2023

Related U.S. Application Data
(60) Provisional application No. 63/353,622, filed on Jun. 19, 2022.

(51) Int. Cl. G01B 7/16; G01L 1/22

(52) U.S. Cl. CPC G01B 7/18; G01L 1/2287

(57) ABSTRACT

Direct monitoring of wear, strain and structural integrity allows for monitoring of potentially damaging wear and strain from any orientation or mode and over long stretches of objects or materials Conductive filament is embedded within the wall, or sub-surface of an object or material. The filament may be aligned parallel, perpendicular, or at an appropriate angle to the axis of the object or material to detect wear and loss of integrity respectively.

### FIELD OF THE INVENTION

This invention generally relates to monitoring the wear, strain and structural integrity on an object or material, and more particularly, to monitoring the wear, strain and structural integrity on objects or materials that are subject to erosion, wash, wear, fatigue, stress, strain, pressure or flow.

### BACKGROUND OF THE INVENTION

Most objects or materials, over time, are subject to erosion, wash, wear, fatigue, stress, strain, pressure or flow. These forces can occur on exterior, and or interior surfaces, visible and non-visible. These forces threaten the overall integrity of the object or material. With the ability to monitor these forces over the life of the object or material, assessments can be made to either repair or replace the object or material when it is determined that these forces have affected the integrity of the object or material.

Currently erosion, wash, wear, fatigue, stress or strain on an object or material is typically performed visually. A technician will visually inspect any visible surfaces on an object or material and determine by best guess if the object or material has endured an excessive level of these forces. A judgement will then be made on the technicians' part of whether the object or material should be deemed good for continued use or not.

There are other ways of trying to determine wear or integrity of objects or materials, these ways typically involve using an array of Fiber Optics, Sensors, Transducers, Calipers or other apparatus. These are typically costly and not always efficient, and most of them are not ideal for determining wash, wear, fatigue, stress or strain on internals of an object or material.

### SUMMARY OF THE INVENTION

Improved methods and apparatuses for directly monitoring object or material wash, wear, fatigue, stress, strain or structural integrity are disclosed that allows for monitoring of potentially damaging wash, wear, fatigue, stress, or strain from any orientation or mode and over long stretches on objects and materials. In a preferred embodiment, conductive filament is embedded on the surface, or sub-surface, installed there during the manufacturing process, or added post manufacturing. The conductive filament may be aligned parallel, perpendicular, or at an appropriate angle to the axis of the object or material to detect wear and loss of integrity respectively. The filament is conductive and is capable of measuring electrical resistance. Analysis of electrical resistance throughout the conductive filament includes techniques for assessment of resistance levels throughout the conductive filament. Assessment of the resistance at various levels allows for the determination of wash, wear, fatigue, stress, strain or structural integrity. Two leads are mounted on or near the object or material, these leads are directly attached and associated with the conductive filament that is installed or embedded onto the surface, or sub-surface of the object or material. Through the use of a standard Multimeter, the resistance level of the conductive filament can be measured by attaching the leads of the Multimeter to the leads from the conductive filament.

### BRIEF DESCRIPTION OF THE DRAWINGS

The foregoing and other features and aspects of the present disclosure will be best understood with reference to the following detailed description of specific embodiments of the invention, when read in conjunction with the accompanying drawings, wherein:

FIG. 1 depicts a side view of the present invention wherein an array of conductive filament is embedded or installed helically around a center axis. 1 also depicts a standard multimeter apparatus which is used to test the leads of the conductive filament. This depicts the use with an elastomer tube.

FIG. 2 depicts an exploded side view of the conductive filament and leads arrangement shown in FIG. 1.

FIG. 3 depicts a cross sectional side view of the conductive filament arrangement shown in FIG. 1 taken perpendicularly to the axis of the elastomer tube.

FIG. 4 depicts an end view of the present invention wherein a conductive filament is embedded or installed helically around a center axis, allowing the conductive filament to detect wear, strain and structural integrity of the object or material, perpendicular to the axis of the elastomer tubing.

FIG. 5 depicts a top view of the present invention wherein a conductive filament is embedded or installed helically around a center axis, allowing the conductive filament to detect wear, strain and structural integrity of the object or material, perpendicular to the axis of the elastomer tubing.

FIG. 6 depicts a side view of the present invention wherein a conductive filament is embedded or installed horizontally around a center axis, allowing the conductive filament to detect wear, strain and structural integrity of the object or material. This depicts the use with an elastomer tube.

FIG. 7 depicts an aerial view of the present invention wherein a conductive filament is embedded or installed horizontally around a center axis, allowing the conductive filament to detect wear, strain and structural integrity of the object or material. This depicts the use with an elastomer tube.

FIG. 8 depicts a top view of the present invention wherein a conductive filament is embedded or installed vertically around a center axis, allowing the conductive filament to detect wear, strain and structural integrity of the object or material. This depicts the use with a wind turbine blade.

FIG. 9 depicts a side view of the present invention wherein a conductive filament is embedded or installed helically around a center axis, allowing the conductive filament to detect wear, strain and structural integrity of the object or material. This depicts the use with a rubber tire.

FIG. 10 depicts an aerial view of the present invention wherein a conductive filament is embedded or installed helically around a center axis, allowing the conductive filament to detect wear, strain and structural integrity of the object or material. This depicts the use with a rubber tire.

FIG. 11 depicts a side view of the present invention wherein a conductive filament is embedded or installed helically around a center axis, allowing the conductive filament to detect wear, strain and structural integrity of the object or material. This depicts the use with an expansion joint.

FIG. 12 depicts an aerial view of the present invention wherein a conductive filament is embedded or installed helically around a center axis, allowing the conductive filament to detect wear, strain and structural integrity of the object or material. This depicts the use with an expansion joint.

### DETAILED DESCRIPTION OF EMBODIMENTS OF THE INVENTION

In the disclosure that follows, in the interest of clarity, not all features of an actual implementation of a wear integrity monitoring system are described in this disclosure. It will of course be appreciated that in the development of any such actual implementation of the disclosed invention, as in any such project, numerous engineering and design decisions must be made to achieve the developers' specific goals, e.g., compliance with mechanical and business related constraints, which will vary from one implementation to another. While attention must necessarily be paid to proper engineering and design practices for the environment in question, it should be appreciated that development of a wear integrity monitoring system would nevertheless be a routine undertaking for those of skill in the art given the details provided by this disclosure, even if such development efforts are complex and time-consuming. As used herein measurement of resistance could also mean measurement of conductivity.

The disclosed embodiments are useful in directly monitoring wear, strain and structural integrity and particularly when the wear reaches a level that can threaten the structural integrity of the object or material. The disclosed embodiments preferably use conductive filament, which provide a large number of options for measuring the wear and strain imposed on an object or material and which offers high reliability. Conductive filaments also have the additional benefit that they can be easily embedded in, or installed onto multiple configurations, and patterns to allow for several leads to be connected in series, or to be connected to other multimeters that measure resistance and conductivity.

At a 1%-100% axial wear (i.e., parallel to the axis), an object or material would be expected to undergo significant deformation and possible catastrophic failure. The embedded conductive filament is embedded into the wall material, or onto the surface of the object or material or at perhaps at plurality of depths from the surface to detect advancement of wear. However, preferably it is embedded or installed at a depth or thickness equal to the minimum wall thickness required by the manufacturer to ensure full structural integrity of the object or material. Once the object or material has worn away enough to reveal the embedded conductive filament, or has eroded the conductive filament, the conductive filament will become compromised. Using a standard multimeter, the two leads attached to the conductive filament can be tested and the level of resistance can be measured. A compromised conductive filament will give a different resistance measurement than that performed on an intact conductive filament. Once it is determined that the resistance measurements indicate a compromised conductive filament, action can be taken to either repair or replace the compromised object or material.

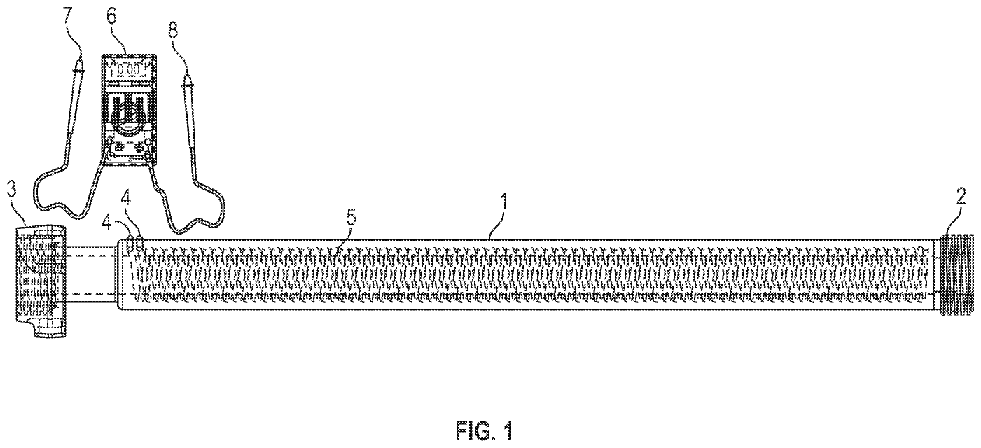

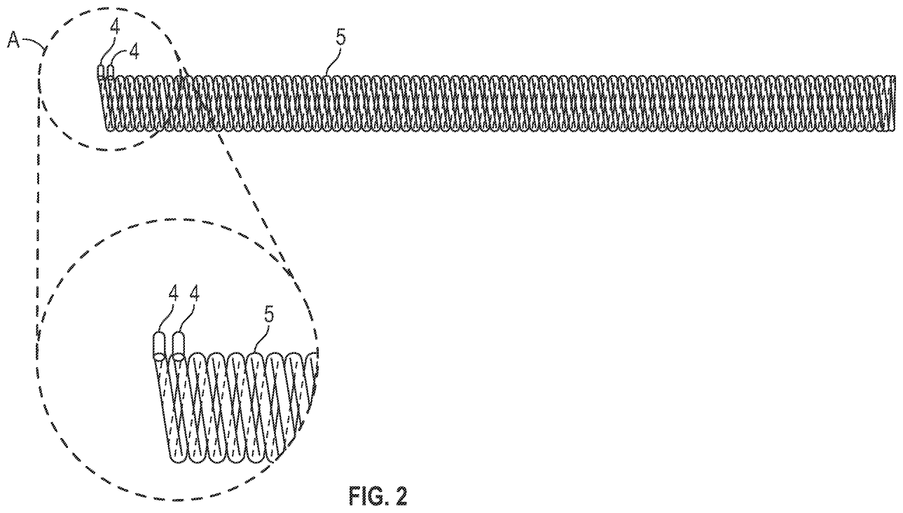

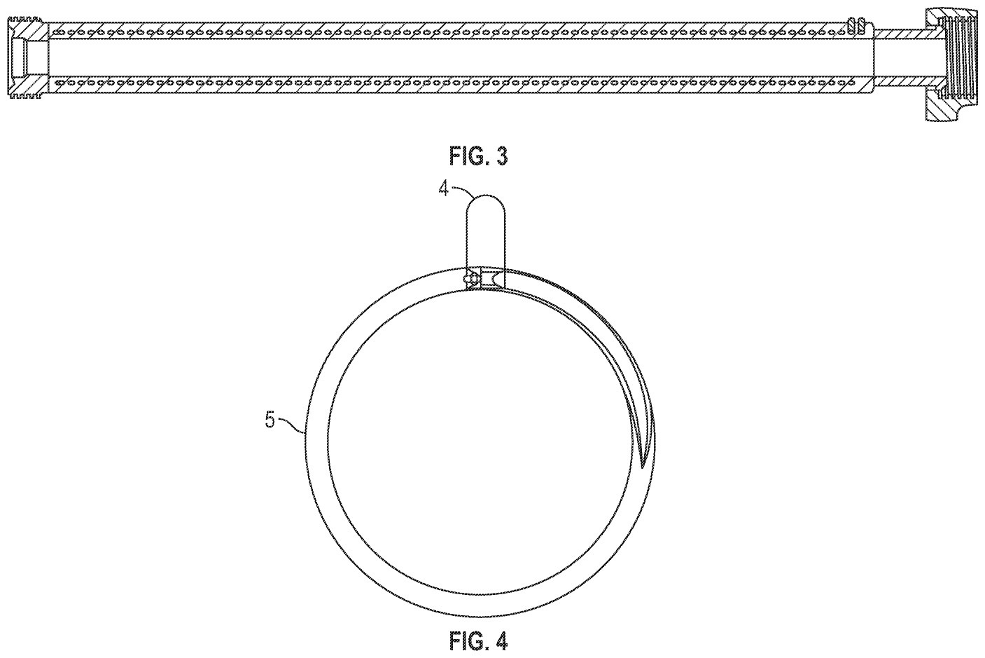

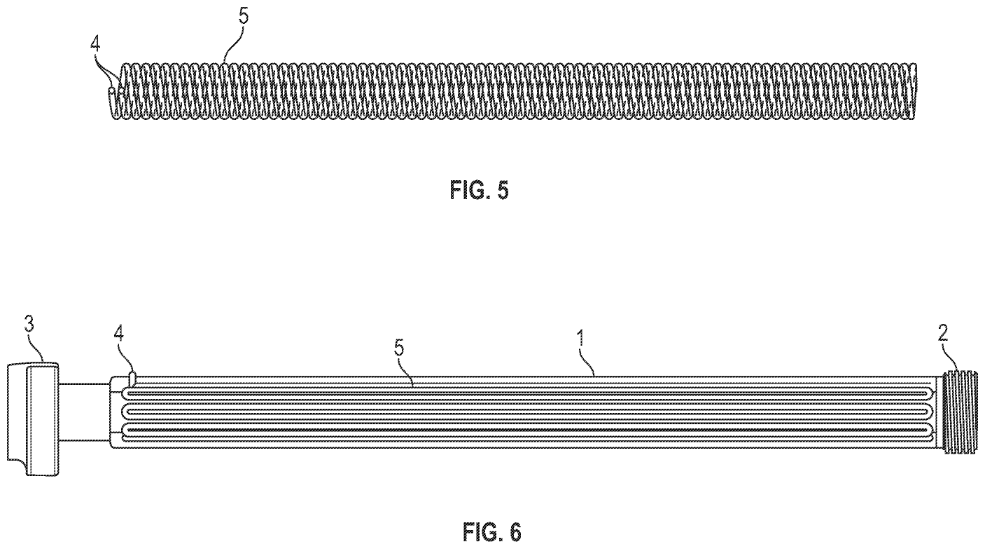

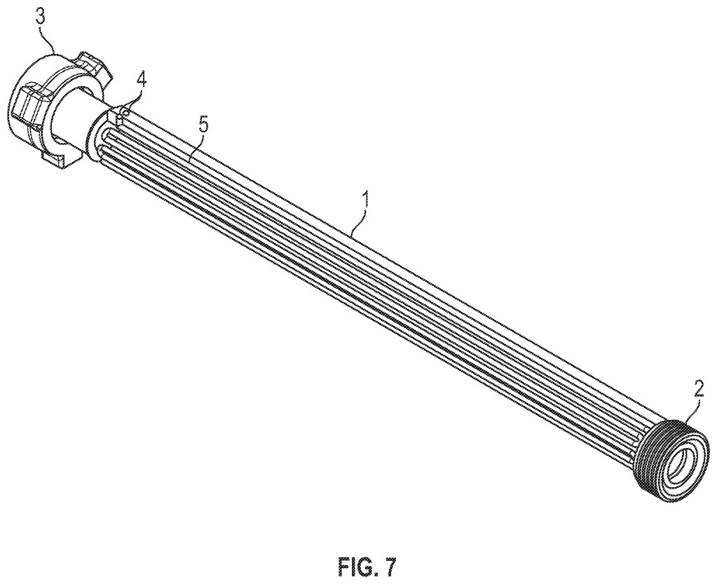

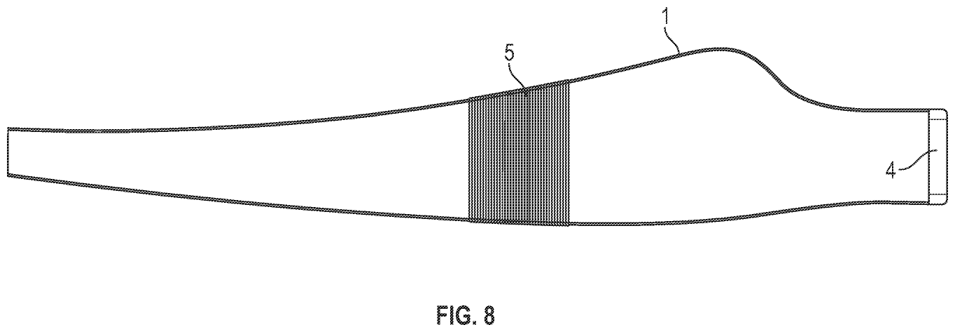

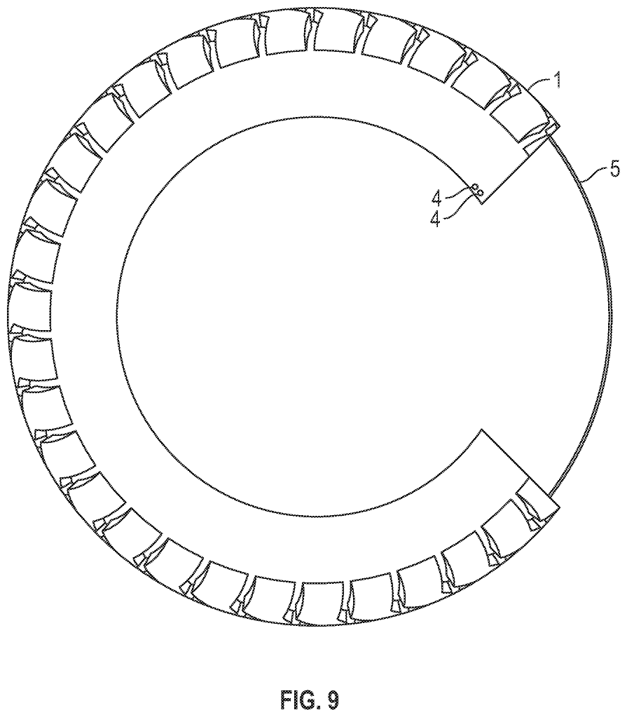

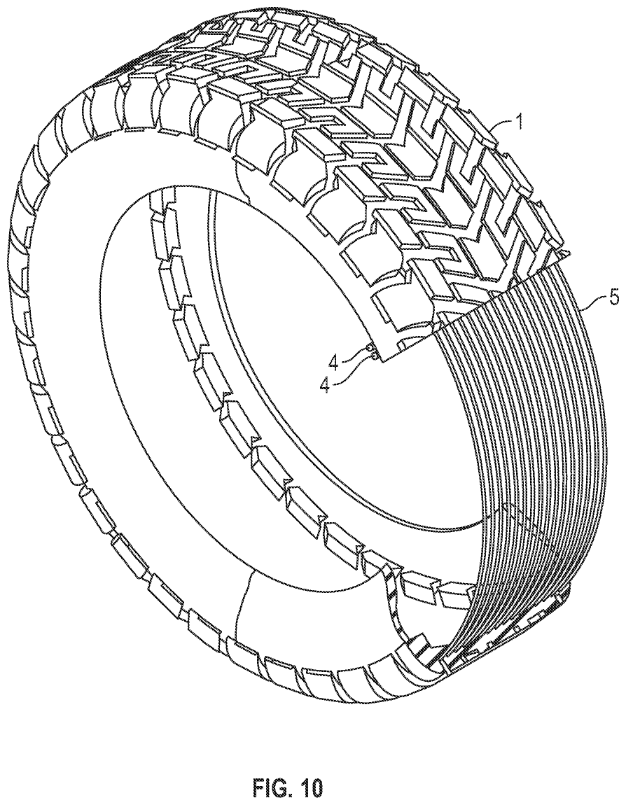

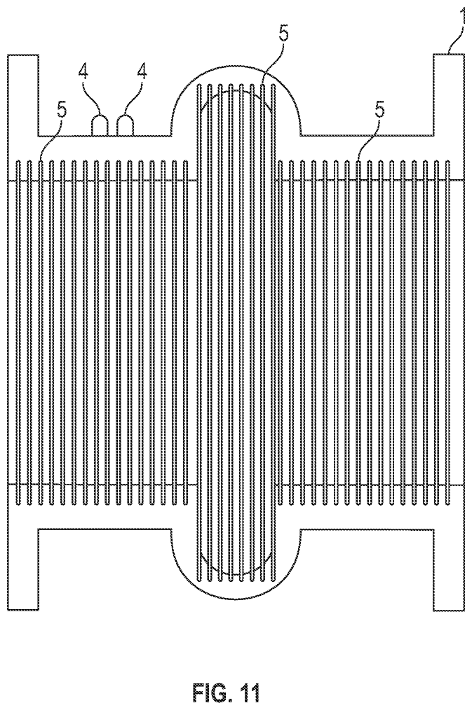

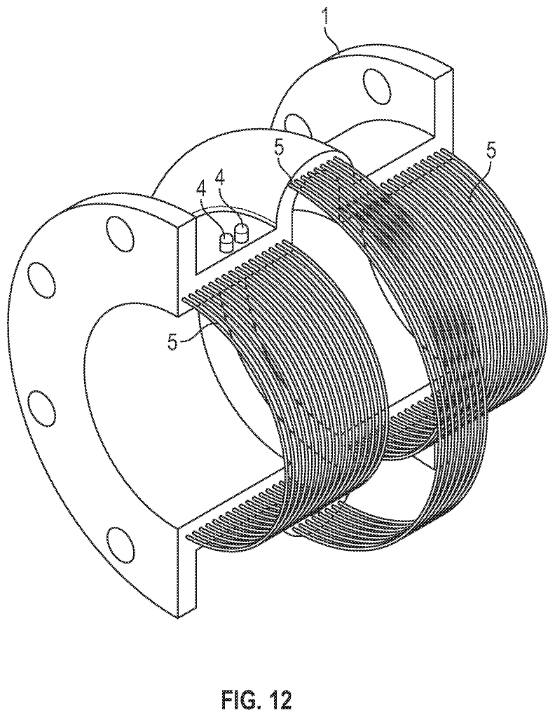

FIGS. 1 to 12 disclose preferred embodiments of conductive filament for directly monitoring wear, strain and structural integrity of objects and materials by measuring levels of resistance or conductivity through the conductive filament. More specifically, these Figures show a segment of conductive filament 5 embedded into, or installed onto a body 1, and two leads attached to the conductive filament 4. The male end of the

body 3, and the female end of the body 2. A standard multimeter 6, a positive lead 7, and a negative lead 8.

It is contemplated that various substitutions, alterations, and/or modifications may be made to the disclosed embodiment without departing from the spirit and scope of the invention as defined in the appended claims and equivalents thereof.

1. A method for monitoring wear, strain and structural integrity on or in an object, wherein the object is formed about an axis, comprising:
embedding a minimum of one conductive filament into a wall of the object, or installing a conductive filament onto a surface of the object;
attaching or extending a minimum of two leads from the conductive filament for measurement; and
measuring and interpreting a level of resistance or conductivity found throughout the conductive filament.

2. The method of claim 1, wherein the conductive filament is embedded horizontally in the object.

3. The method of claim 1, wherein the conductive filament is embedded vertically in the object.

4. The method of claim 1, wherein the conductive filament is embedded helically in the object.

5. The method of claim 1, wherein the conductive filament is embedded in any combination of horizontally, vertically and or helically in the object.

6. The method of claim 1, wherein a plurality of conductive filaments is installed horizontally into the object.

7. The method of claim 1, wherein the conductive filament is installed vertically onto the object.

8. The method of claim 1, wherein the conductive filament is installed helically onto the object.

9. The method of claim 1, wherein the conductive filament is installed in any combination of horizontally, vertically and or helically onto the object.

10. A system for monitoring wear, strain and structural integrity, comprising:
an object to be monitored;
a conductive filament is embedded into a wall of the object; and
a minimum of two leads extending from the conductive filament that are connectable for measurement, whereby measurement of a resistance of the conductive filament for determination of a determination of wear.

11. The system of claim 10, wherein the conductive filament is embedded horizontally in the object.

12. The system of claim 10 wherein the object is formed about an axis and a plurality of conductive are embedded into the wall of the object.

13. The system of claim 10, wherein the object is formed about an axis, and a plurality of conductive filaments are mounted onto the object.

14. The system of claim 10, wherein a plurality of conductive filaments is embedded horizontally in the object.

15. The system of claim 10, wherein the conductive filament is embedded vertically in the object.

16. The system of claim 10, wherein the conductive filament is embedded helically in the object.

17. The system of claim 10 wherein the conductive filament is embedded in any combination of horizontally, vertically and or helically in the object.

18. The system of claim 10, wherein the conductive filament is installed horizontally onto the object.

19. The system of claim 10, wherein the conductive filament is installed vertically onto the object.

20. The system of claim 10, wherein the conductive filament is installed helically onto the object.
